(19) United States
(12) Patent Application Publication
(10) Pub. No.: US 2012/0081636 A1
(43) Pub. Date: Apr. 5, 2012

(54) BACKLIGHT MODULE AND DISPLAY APPARATUS

(75) Inventors: DONG-XIAN YU, Wugu (TW); Cheng-chia Wu, Wugu (TW); Ying-che Huang, Wugu (TW); Wei-chi Lai, Wugu (TW)

(73) Assignee: HANNSTAR DISPLAY CORPORATION, WUGU (TW)

(21) Appl. No.: 13/072,709

(22) Filed: Mar. 26, 2011

(30) Foreign Application Priority Data
Oct. 4, 2010 (TW) 099133769

(51) Int. Cl. G02F 1/13357; F21V 8/00

(52) U.S. Cl. 349/65; 362/613

(57) ABSTRACT

A backlight module and a display apparatus are disclosed. The backlight module comprises a frame, a plurality of light guide units and a plurality of light sources. The frame includes an inside surface and a plurality of positioning convex portions, wherein the positioning convex portions are formed on the inside surface. The light guide units are disposed in the frame and have a plurality of positioning concave portions. The positioning convex portions of the frame correspond to the positioning concave portions of the light guide units, thereby positioning the light guide units in the frame. The light sources are disposed at one side of the light guide units. The backlight module is applicable to the display apparatus.

### FIELD OF THE INVENTION

The present invention relates to a backlight module and a display apparatus, and more particularly, to a backlight module and a display apparatus for positioning a plurality of light guide units.

### BACKGROUND OF THE INVENTION

Liquid crystal displays (LCDs) mostly comprise a liquid crystal panel and a backlight module which is disposed behind the panel. Therefore, the backlight module is one of the key components of an LCD. According to the position of the backlight source, the backlight module can be an edge-lighting type or a bottom-lighting type in order to provide LCD with backlight.

Conventional edge-lighting backlight module uses a light guide plate to guide light through an optical filter for improving optical effect, thereby forming a uniform planar light. A light source is disposed at one side of the light guide plate for lighting, and the liquid crystal panel is disposed on the light source and the light guide plate.

Currently, the light guide plate of the backlight module is formed as one-piece. However, the light guide plate of the backlight module can also be composed of a plurality of light guide units. For example, a light guide plate of a field sequential liquid crystal display (FSC-LCD) can be assembled by light guide units for guiding light into different regions thereof. Therefore, the light guide plate of the FSC-LCD can have a plurality of individual lighting regions.

However, the light guide plate of the backlight module being assembled by the light guide units increases the assembling difficulty of the backlight module, and the position error between the light guide units is susceptible to occur, thus the backlight efficacy thereof is susceptible to be impaired.

### SUMMARY OF THE INVENTION

Therefore, an aspect of the present invention is to provide a backlight module and a display apparatus for positioning a plurality of light guide units in a frame, thereby improving the above-mentioned position error problem and enhancing the assembling quality of the backlight module.

According to an embodiment of the present invention, the backlight module comprises a frame, a plurality of light guide units and a plurality of light sources. The frame includes an inside surface and a plurality of positioning convex portions, wherein the positioning convex portions are formed on the inside surface. The light guide units are disposed in the frame, wherein the light guide units include a plurality of positioning concave portions, and the positioning convex portions of the frame correspond to the positioning concave portions for positioning the light guide units in the frame. The light sources are disposed at one side of the light guide units.

In one embodiment of the present invention, the positioning convex portions are disposed between each two adjacent light guide units, respectively.

In one embodiment of the present invention, the cross-sectional shape of the positioning convex portions is a triangle, a rectangle, a trapezoid or a semicircle.

In one embodiment of the present invention, each of the light guide units has a flat plate structure or a wedge-shaped plate structure.

In one embodiment of the present invention, the positioning convex portions protrude inwards from the inside surface.

In one embodiment of the present invention, the positioning convex portions extend from one side of the frame to another side thereof, and the positioning convex portions are connected between both sides of the frame.

In one embodiment of the present invention, the positioning convex portions and the light sources are disposed at different sides of the frame.

In one embodiment of the present invention, at least one of the positioning convex portions and the light sources are disposed at the same side of the frame.

In one embodiment of the present invention, an area of the top side of the positioning convex portions is same as or smaller than an area of the bottom side thereof.

According to another embodiment of the present invention, the display apparatus comprises a display panel and a backlight module. The backlight module comprises a frame, a plurality of light guide units and a plurality of light sources. The frame includes an inside surface and a plurality of positioning convex portions, wherein the positioning convex portions are formed on the inside surface. The light guide units are disposed in the frame, wherein the light guide units include a plurality of positioning concave portions, and the positioning convex portions of the frame correspond to the positioning concave portions for positioning the light guide units in the frame. The light sources are disposed at one side of the light guide units.

Therefore, with the use of the backlight module and the display apparatus disclosed in the embodiments of the present invention, the light guide units can be assembled and positioned in the frame precisely and rapidly, thereby reducing the assembling time and labor, and enhancing the assembling quality thereof.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a cross-sectional view showing a backlight module and a liquid crystal display panel according to a first embodiment of the present invention;

FIG. 2 is a top view showing the backlight module according to the first embodiment of the present invention;

FIG. 3 is a cross-sectional view showing the backlight module according to the first embodiment of the present invention;

FIG. 4A through FIG. 4D are cross-sectional views showing positioning convex portions according to the present invention;

FIG. 5 is a cross-sectional view showing a light source and a light guide unit according to a second embodiment of the present invention;

FIG. 6 A and FIG. 6B are schematic diagrams showing a frame according to a third embodiment of the present invention; and

FIG. 7 is a schematic diagram showing a frame according to a fourth embodiment of the present invention

### DETAILED DESCRIPTION OF THE PREFERRED EMBODIMENT

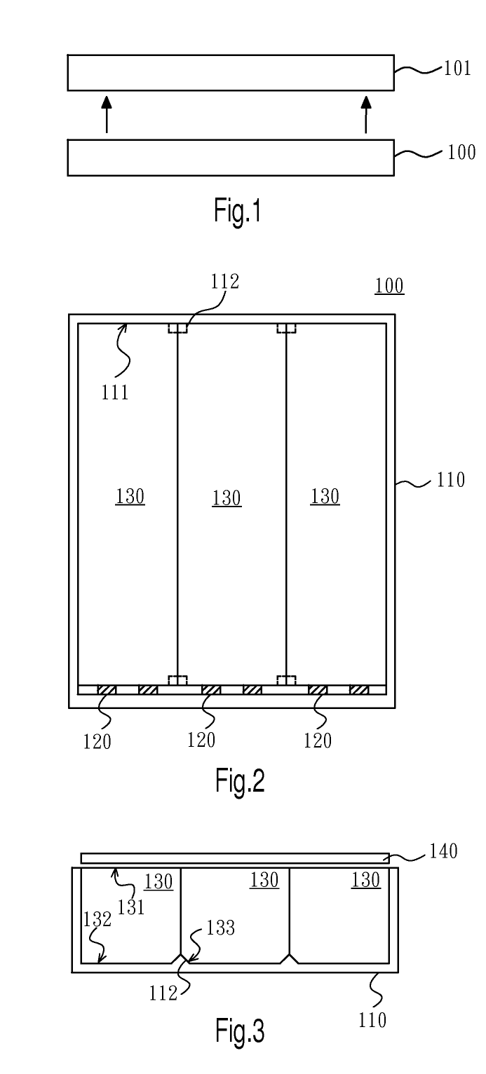

In order to make the illustration of the present invention more explicit and complete, the following description is stated with reference to FIG. 1 through FIG. 7.

In the drawings, similar reference numerals indicate similar components or items.

Referring to FIG. 1 through FIG. 3, FIG. 1 is a cross-sectional view showing a backlight module and a liquid crystal display panel according to a first embodiment of the present invention, and FIG. 2 is a top view showing the backlight module according to the first embodiment of the present invention, and FIG. 3 is a cross-sectional view showing the backlight module according to the first embodiment of the present invention. The backlight module 100 of the present embodiment is disposed opposite to the liquid crystal display panel 101 for being an edge-lighting backlight module of a liquid crystal display apparatus, such as an FSC-LCD. The backlight module 100 comprises a frame 110, a plurality of light sources 120, a plurality of light guide units 130, and optical films 140. The frame 110 is configured to assemble the light sources 120 and the light guide units 130. The light sources 120 are disposed at one side of the light guide units 130 to laterally emit light into the light guide units 130, and the light guide units 130 guide light to output. The optical films 140 are disposed above the light guide units 130 for improving optical effect.

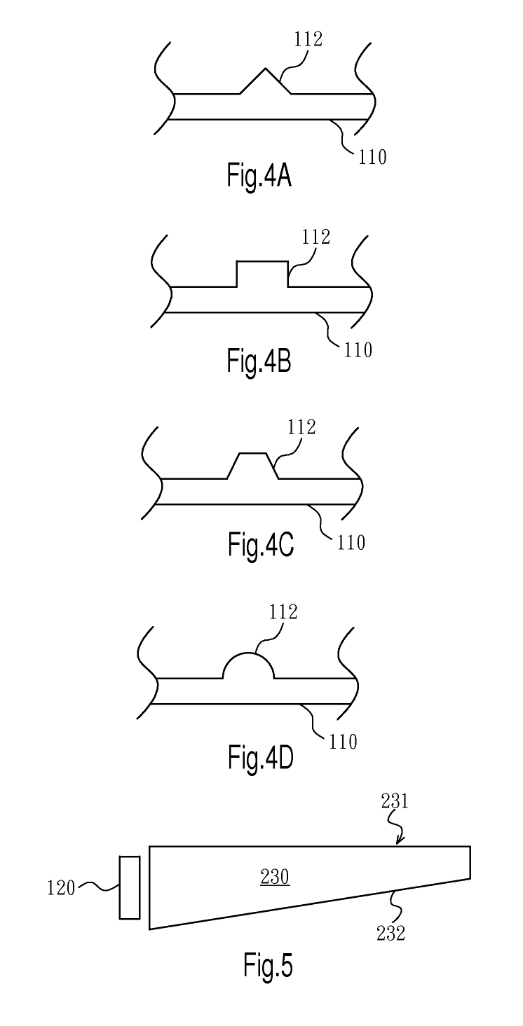

Referring to FIGS. 2 and 3 again, the frame 110 of the present embodiment may be made of an opaque material, such as plastic, metal or any combination material thereof. The frame 110 includes a surrounding inside surface 111 and a plurality of positioning convex portions 112. The positioning convex portions 112 are formed on the inside surface 111 for positioning the light guide units 130 in the frame 110. The positioning convex portions 112 may be formed as one-piece together with the frame 110. Alternatively, the positioning convex portions 112 may be bonded to the inside surface 111 of the frame 110 accordingly. In this embodiment, two positioning convex portions 112 and the light sources 120 may be disposed at the same side of the frame 110, and another two positioning convex portions 112 may be disposed at the opposite side thereof. Furthermore, the positioning convex portions 112 may be disposed between each two adjacent light guide units 130, respectively, for separating the light emitted by the light guide units 130, thereby separating the light of different regions. The positioning convex portions 112 are preferably positioned at the bottom (i.e. opposite to the lighting side of the backlight module 100) of the inside surface 111. In this embodiment, the positioning convex portions 112 protrude inwards from the inside surface 111 (such as toward the center of the frame 110). The positioning convex portions 112 may have cross-sections with different shapes, such as a triangle (referring to FIG. 4A), a rectangle (referring to FIG. 4B), a trapezoid (referring to FIG. 4C), a semicircle (referring to FIG. 4D), etc. Furthermore, an area of the top side (i.e. in respect to the lighting side of the backlight module 100) of the positioning convex portions 112 is preferably smaller than an area of the bottom side (i.e. opposite to the lighting side) thereof.

Referring to FIG. 2 again, the light sources 120 of the present embodiment may be light emitting diodes (LEDs) or organic light emitting diodes (OLEDs) to emit light to the light guide units 130. In this embodiment, the light sources 120 may be the LEDs with different color light. In one embodiment, the light sources 120 may be disposed at both opposite sides to emit light to the light guide units 130, respectively.

Referring to FIGS. 2 and 3 again, the light guide units 130 of the present embodiment may be arranged horizontally to be a light guide plate for guiding the light of the light sources 120 to the liquid crystal display panel 101 and forming a plurality of lighting regions. The light guide units 130 may be made by a method of injection molding, and the material thereof may be photo-curable resin, polymethyl-methacrylate (PMMA) or polycarbonate (PC).

Referring to FIG. 3 again, each of the light guide units 130 may have a light output surface 131, a light reflection surface 132 and at least one positioning concave portion 133. The light output surface 131 is formed on one side of the light guide unit 130 and facing the liquid crystal display panel 101. The light output surfaces 131 may include a frosted surface or a plurality of scattered patterns to make uniform the light outputted from the light guide unit 130, thus the phenomenon of Mura can be prevented. In one embodiment, the light output surface 131 may include a plurality of protruding structures (not shown) to modify the direction of light, thereby condensing light and enhancing the brightness thereof, wherein the protruding structures may be convex or concave structures, such as prism-shaped structures or semicircle-shaped structures. The light reflection surface 132 is formed opposite to the light output surface 131 for reflecting light thereto. In the present embodiment, the light guide unit 130 is a flat plate structure. At this time, the light reflection surface 132 may have a plurality of light guiding structures (not shown) formed thereon to guide the light emitted from the light source 120 to the light output surface 131.

Referring to FIGS. 2 and 3 again, the positioning concave portion 133 of the light guide unit 130 of the present embodiment is formed on the light reflection surface 132, wherein the positioning convex portions 112 of the frame 110 can correspond to the positioning concave portion 133 of the light guide unit 130 for positioning the light guide unit 130 in the frame 110, i.e. the shape of the positioning concave portion 133 of the light guide unit 130 corresponds to the shape of the positioning convex portions 112 of the frame 110, thereby allowing the positioning concave portion 133 of the light guide unit 130 to engage with the positioning convex portions 112 of the frame 110. Since the area of the top side of each the positioning convex portions 112 is same as or smaller than the area of the bottom side thereof, the positioning concave portion 133 can engage with the positioning convex portions 112.

Referring to FIGS. 2 and 3 again, in the present embodiment, the positioning concave portions 133 are formed between each two adjacent light guide units 130 for engaging with the positioning convex portions 112. At this time, two adjacent positioning concave portions 133 can engage with one positioning convex portion 112 for positioning the light guide unit 130 in the frame 110.

Referring to FIG. 3 again, the optical film 140 of the present embodiment may be a diffuser, a prism sheet, a turning prism sheet, a brightness enhancement film, a dual brightness enhancement film, a diffused reflective polarizer film or any combination thereof and is disposed above the light guide unit 130 for improving optical effect.

The backlight module 100 of the present embodiment may further comprise a reflective layer (not shown) formed on the light reflection surface 132 of the light guide unit 130 for reflecting light. The reflective layer may be made of a highly reflective material, such as Ag, Al, Au, Cr, Cu, In, Ir, Ni, Pt, Re, Rh, Sn, Ta, W, Mn, alloy of any combination thereof, white reflective paint with etiolation-resistant and heat-resistant properties or any combination thereof for reflecting light.

Referring to FIGS. 2 and 3 again, when assembling the light guide units 130 of the backlight module 100, the light guide units 130 can be arranged and positioned in the frame 110 horizontally due to the positioning convex portions 112 of the frame 110, and the unexpected gap formed between the light guide units 130 can be reduced. Furthermore, the light guide units 130 can be assembled in the frame 110 simply and rapidly, thereby reducing the assembling time of the backlight module.

Referring to FIGS. 2 and 3 again, in the present embodiment, three light guide units 130 are arranged in the frame 110 horizontally, and two positioning convex portions 112 and the light sources 120 may be disposed at the same side of the frame 110, and another two positioning convex portions 112 are disposed at another opposite side thereof, wherein the positioning convex portions 112 may disposed between each two adjacent light guide units 130 to position the light guide units 130 in the frame 110. However, the number and position of the positioning convex portions 112 and the light guide units 130 may be determined according to a real situation but not limited to the above description.

Referring to FIG. 5, a cross-sectional view showing a light source and a light guide unit according to a second embodiment of the present invention is presented herein. Some reference numerals shown in the first embodiment are used in the second embodiment of the present invention. The construction of the second embodiment is similar to that in the first embodiment with respect to configuration and function, and thus is not stated in detail herein.

Referring again to FIG. 5, in comparison with the first embodiment, the light guide units 230 of the second embodiment may have a wedge-shaped plate structure, wherein the thickness thereof that is closes to the light source 120 is thicker than the thickness thereof that is away from the light source 120. At this time, the light reflection surface of the light guide units 230 may not have the light guiding structures, but uses the inclined plane (i.e. the light reflection surface 232) of the light guide units 230 to reflect the light to be outputted from the light output surface 231.

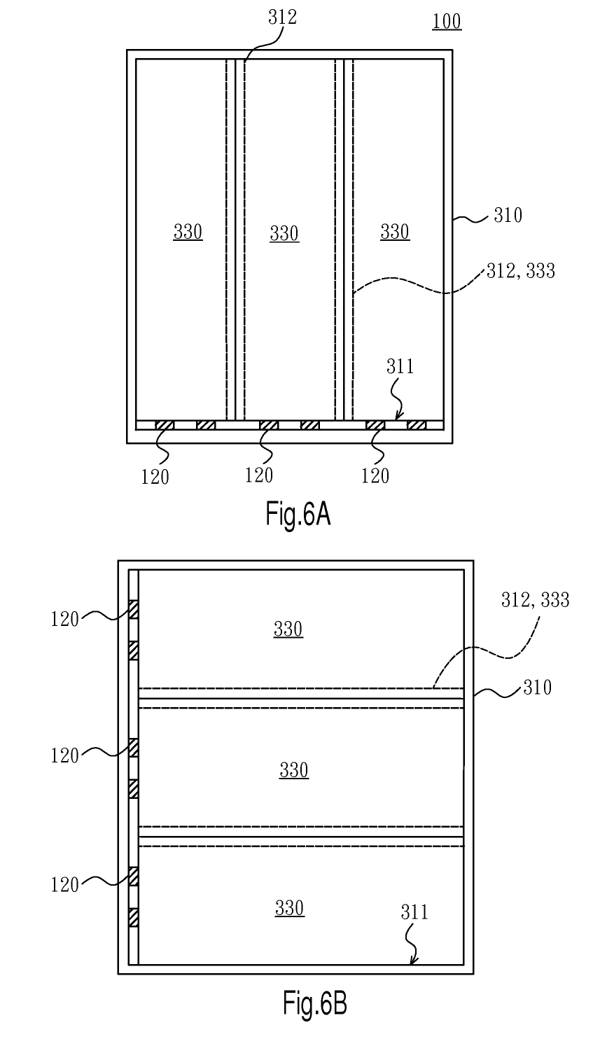

Referring to FIGS. 6 A and 6B, schematic diagrams showing a frame according to a third embodiment of the present invention are presented herein. Some reference numerals shown in the first embodiment are used in the third embodiment of the present invention. The construction of the third embodiment is similar to that in the first embodiment with respect to configuration and function, and thus is not stated in detail herein.

Referring again to FIGS. 6 A and 6B, in comparison with the first embodiment, the frame 310 includes a surrounding inside surface 311 and a plurality of positioning convex portions 312, wherein the positioning convex portions 312 extend from one side of the frame 310 to another side thereof. The elongated positioning convex portions 312 are connected between both sides of the frame 310 for positioning the light guide units 330 in the frame 310, and the positioning convex portions 312 may be disposed between each two adjacent light guide units 330 (referring to FIG. 6A) or other positions (referring to FIG. 6B), respectively. At this time, the shape and position of the positioning concave portions 333 of the light guide units 330 correspond to the positioning convex portions 312 of the frame 310, thereby allowing the positioning concave portions 333 engaging with the positioning convex portions 312.

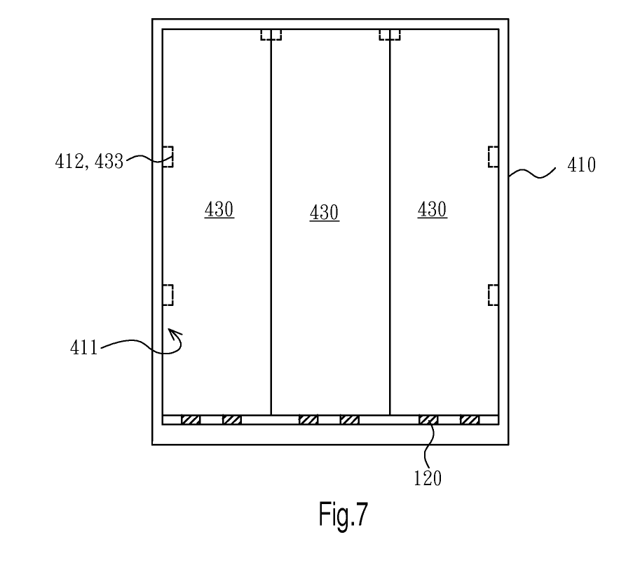

Referring to FIG. 7, a schematic diagram showing a frame according to a fourth embodiment of the present invention is presented herein. Some reference numerals shown in the first embodiment are used in the fourth embodiment of the present invention. The construction of the fourth embodiment is similar to that in the first embodiment with respect to configuration and function, and thus is not stated in detail herein.

Referring again to FIG. 7, in comparison with the first embodiment, the frame 410 includes a surrounding inside surface 411 and a plurality of positioning convex portions 412, wherein the positioning convex portions 412 and the light sources 120 may be disposed at different sides of the frame 410. At this time, the positioning convex portions 412 can be disposed at any position of the inside surface 411, and the positioning convex portions 412 may be disposed between each two adjacent light guide units 430 or other positions, respectively. The shape and position of the positioning concave portions 433 of the light guide units 430 correspond to the positioning convex portions 412 of the frame 410, thereby allowing the positioning concave portions 433 engaging with the positioning convex portions 412.

As described above, the backlight module and the display apparatus of the present invention can utilize the position portions of the frame to position the light guide units in the frame simply and rapidly, thereby reducing the assembling time and labor, and further reducing the position error formed between the light guide units.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A backlight module comprising:
a frame including an inside surface and a plurality of positioning convex portions, wherein the positioning convex portions are formed on the inside surface;
a plurality of light guide units disposed in the frame, wherein the light guide units include a plurality of positioning concave portions, and the positioning convex portions of the frame correspond to the positioning concave portions for positioning the light guide units in the frame; and
a plurality of light sources disposed at one side of the light guide units.

2. The backlight module as claimed in claim 1, wherein the positioning convex portions are disposed between each two adjacent light guide units, respectively.

3. The backlight module as claimed in claim 1, wherein a cross-sectional shape of the positioning convex portions is a triangle, a rectangle, a trapezoid or a semicircle.

4. The backlight module as claimed in claim 1, wherein each of the light guide units has a flat plate structure or a wedge-shaped plate structure.

5. The backlight module as claimed in claim 1, wherein the positioning convex portions protrude inwards from the inside surface.

6. The backlight module as claimed in claim 1, wherein the positioning convex portions extend from one side of the frame to another side thereof, and the positioning convex portions are connected between both sides of the frame.

7. The backlight module as claimed in claim 1, wherein the positioning convex portions and the light sources are disposed at different sides of the frame.

8. The backlight module as claimed in claim 1, wherein at least one of the positioning convex portions and the light sources are disposed at the same side of the frame.

9. The backlight module as claimed in claim 1, wherein the area of the top side of the positioning convex portions is identical to or smaller than the area of the bottom side thereof.

10. A display apparatus comprising:
a backlight module comprising:
a frame including an inside surface and a plurality of positioning convex portions, wherein the positioning convex portions are formed on the inside surface;
a plurality of light guide units disposed in the frame, wherein the light guide units include a plurality of positioning concave portions, and the positioning convex portions of the frame correspond to the positioning concave portions for positioning the light guide units in the frame; and
a plurality of light sources disposed at one side of the light guide units; and a display panel disposed on the backlight module.
